(19) United States
(12) Patent Application Publication
(10) Pub. No.: US 2015/0251681 A1
(43) Pub. Date: Sep. 10, 2015

(54) Detachable Stroller Handle Tray

(71) Applicant: Nancy Castillo, Pauma Valley, CA (US)

(72) Inventor: Nancy Castillo, Pauma Valley, CA (US)

(21) Appl. No.: 14/589,986

(22) Filed: Jan. 5, 2015

Related U.S. Application Data
(60) Provisional application No. 61/947,546, filed on Mar. 4, 2014.

(51) Int. Cl. B62B 9/26

(52) U.S. Cl. CPC B62B 9/26

(57) ABSTRACT

A collapsible tray for attachment to the handle bar(s) of a stroller or other handcart is provided. The tray may have a planar bottom bounded by at least one sidewall, and may have two arms pivotably attached to the side wall(s) such that they can pivot from a horizontal collapsed configuration into an upstanding deployed configuration. Fasteners disposed at free ends o f the arms removably secure to the handle bar(s) of a stroller. The fasteners preferably have a width lessen than the height of the one or more sidewalls so that the fasteners fit neatly within the tray interior when the arms are collapsed for storage. In this manner the invention provide stroller operators with a convenient easy to reach location to place articles thereon.

### CROSS REFERENCE TO RELATED APPLICATION

This application claims the benefit of U.S. Provisional Application No. 61/947546 filed on Mar. 4, 2014. The above identified patent application is herein incorporated by reference in its entirety to provide continuity of disclosure.

### BACKGROUND OF THE INVENTION

1. Field of the Invention

The present invention relates to article storage. More specifically, it relates a collapsible tray that removable attaches to the handle of a stroller, walker, or other manually manipulated cart. The tray enables persons pushing a cart to have ready access to food and beverage items, without having to hold the items themselves.

Hand carts such as baby strollers, shopping carts, and walkers are all comprised of one or more sets of wheels attached to a frame with a handle. The cart operator grasps the handle and walks forward, exerting force on the handle in the direction of motion. As the operator moves, so too does the cart. Some carts are adapted for carrying or transporting items. Grocery carts and strollers both contain a central storage portion where goods, or a child may be safely placed while the cart is in operation. Walkers on the other hand, may have a deployable seat, to enable sitting after cessation of operation, or alternatively may comprises only the skeletal frame.

Few carts include storage containers or trays within reaching distance of the cart handle. Without a place to place loose articles, or food and beverage containers, cart operators are forced to hold loose articles while holding onto the art handle. Operators frequently drop loose items and must cease cart operation in order to pick up the articles. Other operators forego carrying extraneous articles altogether in an effort to minimize the time spent bending over to pick up dropped items.

Some handcarts do feature built-in beverage trays or article holders. These extensions tend to be bulky and do not detach from the handle of the cart. This can make it difficult for operators to store large or oddly sized items.

A detachable article retainer is needed that can easily secure to the handle of a handcart. The present invention is a storage tray that is designed to removably secure to the handle of a handcart, in order to store loose articles while the cart is in operation.

2. Description of the Prior Art

Devices have been disclosed in the prior art that relate to article containers for strollers. These include devices that have been patented and published in patent application publications. These devices generally relate to food and beverage containers. The following is a list of devices deemed most relevant to the present disclosure, which are herein described for the purposes of highlighting and differentiating the unique aspects of the present invention, and further highlighting the drawbacks existing in the prior art.

Pike et al, U.S. Pat. No. 7,413,213 discloses a stroller with releaseably coupled cup holders. The cup holders are elongated members with cup holder sections disposed at opposing ends. Attached to the cup holder sections are two clamps that may grip the frame of the stroller. Unlike the present invention, the Pike cup holder does not provide a storage tray, nor does it provide freely rotatable clamps that enable repositioning of the cup holder with respect to the stroller frame.

Moore, U.S. Patent Publication No. 2011/0210531 discloses a removable stroller tray. The tray has multiple sidewalls surrounding a centralized compartmented portion. At opposing ends of the tray are two buckle release mechanisms. Mating portions of the buckle release mechanisms attach to the stroller. In this way, the tray can be quickly snapped into position, or removed from the stroller frame. This stroller tray does not have the articulating arms of the present invention.

Dixon et al, U.S. Pat. No. 6,766,930 discloses a basket that removably secures to the handle of a stroller. The basket is constructed of a mesh material and has three straps. The straps extend from laterally opposing sides as well as one vertical strap. Each strap has a button closure that facilitates formation of a closed loop. The loops can be secured around portions of the stroller handle to hold the basket in place. Unlike the present invention, the Dixon device does not feature a tray or articulating arms.

These prior art devices have several known drawbacks. None of them have articulable arms that permit repositioning of the tray with respect to a stroller handle. The present invention provides an article holding tray that can be repositioned with respect to the stroller. Making it convenient and easy for use with strollers of a variety of frame configurations. It substantially diverges in design elements from the prior art and consequently it is clear that there is a need in the art for an improvement to existing devices. In this regard the instant invention substantially fulfills these needs.

### SUMMARY OF THE INVENTION

In view of the foregoing disadvantages inherent in the known types of collapsible trays now present in the prior art, the present invention provides a new stroller mounted wherein the same can be utilized for providing convenience for the user when supporting various items while pushing a stroller or other hand cart.

It is therefore an object of the present invention to provide a new and improved collapsible tray device that has all of the advantages of the prior art and none of the disadvantages.

it is another object of the present invention to provide a collapsible tray that can be removably secured to the handle bar(s) of a handcart or stroller and bear loads placed on said tray.

Another object of the present invention is to provide a flat surface within a bounded region, upon which drinks and other volatile items may be placed.

Yet another object of the present invention is to provide a tray that attaches to a stroller handle bar and thus places food and drink items, cell phones, car keys and the like, within arms reach of a hand cart or stroller operator.

Still another object of the present invention is to provide a collapsible tray that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the detachable tray affixed to an exemplary stroller handle and in use.

FIG. 2 shows a perspective view of the detachable tray affixed to the handle area of a stroller.

FIG. 3 shows a frontal perspective view of the detachable stowed configuration.

### DETAILED DESCRIPTION OF THE INVENTION

Reference is made herein to the attached drawings. Like reference numerals are used throughout the drawings to depict like or similar elements of the detachable stroller tray. For the purposes of presenting a brief and clear description of the present invention, the preferred embodiment will be discussed as used for retaining loose articles. The figures are intended for representative purposes only and should not be considered to be limiting in any respect.

The present invention is a tray adapted for attachment to a stroller handle. Strollers as described herein are wheeled handcarts adapted for a specific function such as transporting children. These devices typically have a bar-style handle, which is grasped by the user during operation. Force exerted on the handle is transferred through the device to the wheels, resulting in forward motion. As such, stroller handles are generally well adapted to bear load associated with downward and forward exertion of force.

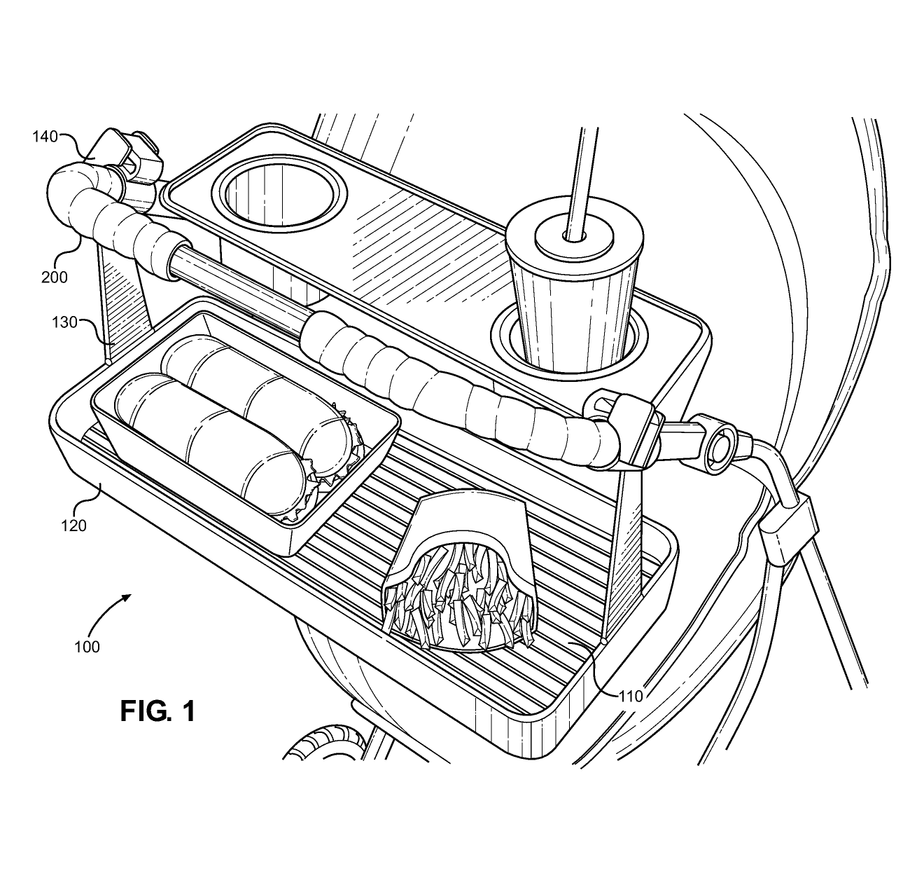

The force bearing characteristics of stroller handles render them well suited to supporting the present detachable stroller tray. As illustrated in FIG. 1, the tray 100 themselves has at least one sidewall 120 and a bottom 110 which define a flat surface with upstanding boundaries. A first arm 130 is attached at a first portion of the sidewall and a second arm 130 is attached at a second portion of the sidewall. Each arm is pivotably attached to its respective sidewall portion and may lay flat or rotate about the pivot joint to extend vertically upward from the tray. Each arm has a fastener 140, such as a clip at an upper end thereof for attachment to the handle bar 200 of a stroller or cart. In the depicted example, the tray serves as a convenient place to store food and other objects while pushing a stroller.

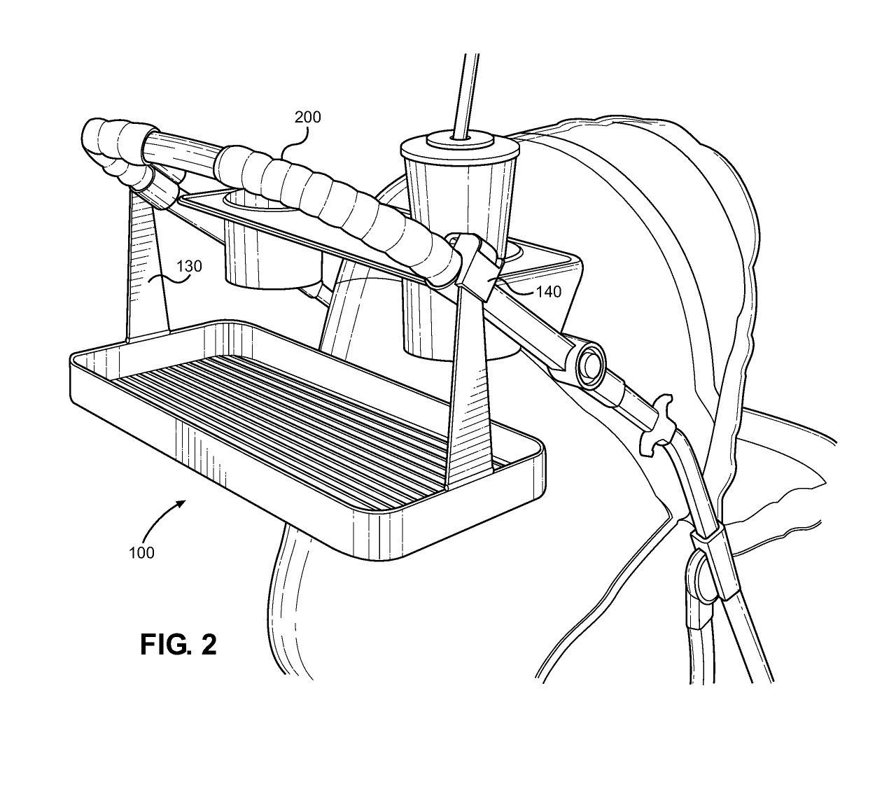

Referring now to FIG. 2, there is shown a perspective view of the detachable stroller tray in use. The tray 100 extends downward from the handle bar 200 of a stroller. Tray arms 130 are oriented vertically upward, in an in use configuration, and their respective fasteners 140 are rotatably secured to the handle 200 of the stroller. The clips may be attached to the arms via joints having multiple degrees of rotation such as ball joints. Enabling the fasteners to rotate and pivot in multiple directions aids users in repositioning the tray with respect to a handle bar. While there is some standardization amongst stroller handles bars, they are not all the same. Some strollers and carts offer two separate handles, while others have a uni-bar design. The ability to rotate and pivot the fasteners of the tray, permit use with a variety of different stroller designs.

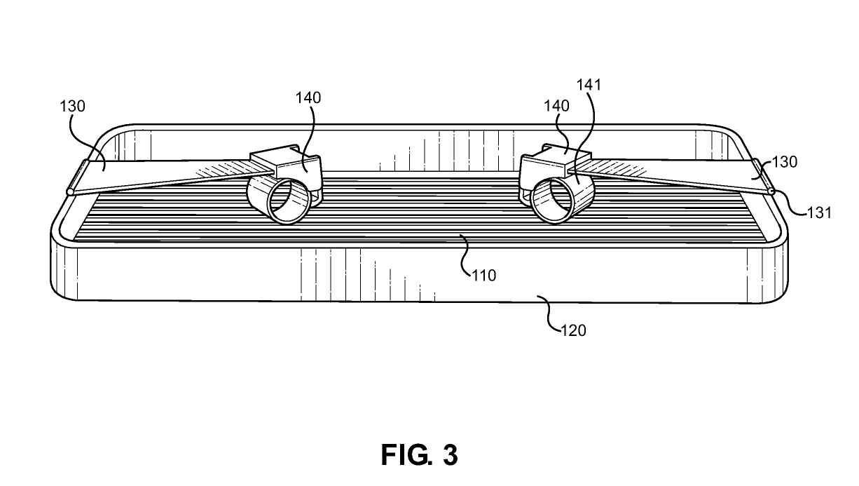

FIG. 3 illustrates a stowed configuration according to various embodiments. Arms 130 may fold down to lie in a position approximately parallel to the bottom 110 of the tray 100. Each arm is affixed to a portion of the one or more sidewalls 130 by a pivot joint 131 that permits ninety-degree rotation of the arm such that it may lie in a horizontal or vertical position. Fasteners 140 are rotatably attached to the free end of each arm. In the depicted example, the fasteners are clips. The body of the clip attaches via a pivot to the arm, and a clamp within the clip body rotates within the body, enabling multiple degrees of rotation. Alternative configurations may include but are not limited to clips that are connected via a ball joint.

Some embodiments of the tray may feature a texture or a tacky material along the upper surface of the tray bottom 110. Ridges, bumps, or the like may be affixed to the upper surface of the bottom to reduce slippage of items placed within the tray. Common uses of the tray will include the placement of food and drink on the upper surface of the bottom. As such, it is advantageous to provide a gripping surface to reduce the chance that drinks and food items will overturn and spill their contents.

The present invention is a portable, detachable tray for retaining food and beverage items, cell phones, car keys, and the like. The tray may be constructed of any durable material such as plastic, rubber, or metal. It may have one sidewall, such as in a circular or ovular shape, or may have multiple sidewalls, such as in rectangular or octagonal shapes. Size, shape and color may vary according to manufacturing concerns and consumer aesthetics

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A collapsible tray for detachable securement to a stroller handle bar, comprising:
a tray having at least one upstanding sidewall and a perimeter;
a bottom joined at said perimeter to said at least one upstanding sidewall and having an upper surface and a lower surface;
a pair of arms pivotably secured to laterally opposing portions of said at least one upstanding sidewall;
fasteners disposed at free ends of said arms, wherein said fasteners are configured to removably secure to a stroller handle bar when in use.

2) The collapsible tray of claim 1, wherein said tray has four upstanding sidewalls joined to said bottom along their lower edges.

3) The collapsible tray of claim 1, wherein said bottom has a raised texture disposed on said upper surface.

4) The collapsible tray of claim 1, wherein said upper surface of said bottom has a non-slip material disposed thereon.

5) The collapsible tray of claim 1, wherein said arms are free to pivot between an upstanding position and a horizontal position.

6) The collapsible tray of claim 1, wherein fasteners are cylindrical clips.

7) The collapsible tray of claim 1, wherein said fasteners are rotatably secured to said arms.

8) A collapsible tray for detachable securement to a stroller handle bar, comprising:
a tray having at least one upstanding sidewall and a perimeter;
a bottom joined at said perimeter to said at least one upstanding sidewall and having an upper surface and a lower surface;
a pair of arms pivotably secured to laterally opposing portions of said at least one sidewall;
fasteners rotatably connected to at free ends of said arms, wherein said fasteners are configured to removably secure to a stroller handle bar when in use.

9) The collapsible tray of claim 8, wherein said tray has four upstanding sidewalls joined to said bottom along their lower edges.

10) The collapsible tray of claim 8, wherein said bottom has a raised texture disposed on said upper surface.

11) The collapsible tray of claim 8, wherein said upper surface of said bottom has a non-slip material disposed thereon.

12) The collapsible tray of claim 8, wherein said arms are free to pivot between an upstanding position and a horizontal position.

13) The collapsible tray of claim 8, wherein fasteners are cylindrical clips.
